(19) United States
(12) Patent Application Publication
(10) Pub. No.: US 2016/0176699 A1
(43) Pub. Date: Jun. 23, 2016

(54) COUPLING ELEMENT

(71) Applicant: ELAFLEX HIBY TANKTECHNIK GMBH & CO. KG, Hamburg (DE)

(72) Inventor: Heinz Ulrich Meyer, Hamburg (DE)

(21) Appl. No.: 14/906,667

(22) PCT Filed: Jul. 11, 2014
(86) PCT No.: PCT/EP2014/064964

§ 371 Date: Jan. 21, 2016

(30) Foreign Application Priority Data
Jul. 24, 2013 (EP) 13177893.8

(51) Int. Cl. B67D 7/32; F16L 15/00; B67D 7/42

(52) U.S. Cl. CPC B67D 7/32; B67D 7/42; F16L 15/00

(57) ABSTRACT

The invention relates to a coupling element (2), which comprises a first liquid connection (3) for connecting to a first part of a liquid line (1) and a second liquid connection (4) for connecting to a second part of a liquid line (5). In addition, the coupling element comprises a break-away coupling (6). The first liquid connection (3) is designed to establish a threaded connection to the first part of the liquid line (1). The two longitudinal axes (7, 8) of the liquid connections (3, 4) lie at an angle to each other. According to the invention, a rotation-preventing element (9) is provided on the first liquid connection (3) of the coupling element (2), which rotation-preventing element permits a relative rotation between the first part of the liquid line (1) and the coupling element (2) if a defined torque acts between the first part of the liquid line (1) and the coupling element (2). Safe operation of the coupling element is ensured by the rotation-preventing element according to the invention.

The invention relates to a coupling element for connecting two parts of a liquid line. The coupling element comprises a first liquid connector and a second liquid connector, wherein the two longitudinal axes of the liquid connectors are angled relative to one another. The first liquid connector is designed to produce a screw connection to the first part of the liquid line. The coupling element also comprises a tear-off coupling.

When refueling motor vehicles, it may be that the pump nozzle is not hung back up in the filling pump once the refueling process is complete, but is left forgotten in the filler neck of the vehicle. If the vehicle then travels off, a tear-off coupling generally provided in the region of the connector end of the pump nozzle ensures that the pump nozzle at this point detaches itself in a defined manner from the pump hose, thus preventing damage to the pump hose or the filling pump. Such a tear-off coupling is known for example from EP 0 555 558 A1.

It is also known from the prior art to design the connection between the pump nozzle and the pump hose in an angled manner. A pump hose angled downwardly relative to the pump nozzle means that the torque which is caused by the force of weight of the pump and which must be compensated for by a user using the force of their hand is reduced. This increases the holding comfort of the pump nozzle.

The object of the present invention is to present a coupling element of the type described in the introduction that is user-friendly and ensures safe operation.

This object is achieved in that an anti-twist means is arranged on the first liquid connector of the coupling element and allows a relative rotation between the first part of the liquid line and the coupling element when a defined torque acts between the first part of the liquid line and the coupling element.

Some terms used within the scope of the invention will first be explained hereinafter.

A liquid line serves to transport liquids. The invention is suitable in particular for liquid lines in the region of filling stations and refinery or chemical plants, more preferably for flexible lines (hoses) which are provided for the filling of such liquids. The first part of the liquid line may for example be a pump nozzle, and the second part of the liquid line may for example be a pump hose.

A liquid connector is a connector for the liquid-tight connection of a liquid line. A liquid connector has a longitudinal axis, which is defined by the axis into which the connector end of the liquid line is directed, said liquid line being connected at the liquid connector. The angle between the two longitudinal axes of the liquid connectors may lie in a range between 0° and 180°. The angle preferably lies between 20° and 70°, more preferably in the region of 45°.

A tear-off coupling is a coupling that is liquid-tight during operation and that can be separated by the application of a defined tensile force and/or a defined tilting moment. The separation preferably occurs without destruction, so that the tear-off coupling after being torn off can be joined together once more and used subsequently.

Because the first liquid connector is designed to produce a screw connection to the first part of the liquid line, the coupling element can be screwed non-rotatably to the first part of the liquid line, such that a relative rotation is initially prevented. A prevention of a relative rotation is often desired in order to increase the operability. The screw connection can be produced for example via a thread and a corresponding mating thread. Here, the thread and the mating thread may have an undefined thread portion. In this way, the coupling element can be rotated relative to the first part of the liquid line about the axis of the first liquid connector in an arbitrary angular position and can then be fixed in this arbitrary angular setting. A tightening torque for fixing and for releasing the screw connection may lie between 5 Nm and 200 Nm, preferably between 10 Nm and 50 Nm.

The anti-twist means according to the invention then allows a rotation when a defined torque acts between the first part of the liquid line and the coupling element. A torque between the first part of the liquid line on the coupling element then acts for example when the first part of the liquid line is fixed and the coupling element is rotated about the longitudinal axis of the first liquid connector. Such a torque also acts when the coupling element is fixed and the first part of the liquid line is rotated about its longitudinal axis, or when a relative rotation takes place in another way between the first part of the liquid line and the coupling element about the above-mentioned axis. If the torque is smaller than the defined torque, the anti-twist means prevents a rotation. Only when the torque reaches a defined torque does the anti-twist means allow a rotation.

The invention has identified that with angled coupling elements from the prior art problems may occur, for example specifically when a pump nozzle is left forgotten in the filler neck of a vehicle and the vehicle then drives off. In the case of modern filling pumps the pump nozzle comes out from the filling pump at a point below the hanging point of the pump nozzle in the filling pump and below the conventional height of the filler neck of a vehicle. If the pump nozzle is inserted into the filler neck of the vehicle, the angled coupling element thus enables the pump hose to be guided in a straight line from the pump nozzle to the point of exit of the pump hose from the filling pump. On account of the angle between the pump nozzle and the pump hose, however, the transfer of force to the tear-off coupling is not optimal if the vehicle then drives off with the pump nozzle inserted. The pump nozzle may tilt in the filler neck, such that no rotation of the pump nozzle is possible. A defined separation at the tear-off coupling then is not ensured in all circumstances. The anti-twist means according to the invention ensures that in the event of a defined torque a rotation takes place between the pump nozzle and the coupling element, such that a defined orientation is set between the pump hose and the pump nozzle. On account of this defined orientation, a correct release of the tear-off securing mechanism is ensured by a defined axial tensile force and/or a defined tilting moment.

A large torque may occur at the connection between the pump nozzle and the coupling element, since the pump hose constitutes a long lever arm, which, when the vehicle drives off, exerts a strong force onto the coupling element. This force may lead inter alia to a rotation of the coupling element about the axis defined by the first liquid connector and to a release of the screw connection between the coupling element and the tilted pump nozzle. The present invention in this context provides the further advantage that the anti-twist means according to the invention prevents a release of the screw connection between the first part of the liquid line and the coupling element, provided the defined torque between the first part of the liquid line and the coupling element is exceeded.

In a preferred embodiment the torque at which the anti-twist means allows a relative rotation between the first part of the liquid line and the coupling element is smaller than the torque necessary to release the screw connection between the coupling element and the first part of the liquid line. This ensures that a rotation takes place before the screw connection between the coupling element and the first part of the liquid line can release. The torque at which the anti-twist means allows a relative rotation is preferably between 10 Nm and 40 Nm, more preferably between 20 Nm and 30 Nm. This selection is advantageous since the torque necessary for releasing the screw connection is usually between 40 Nm and 50 Nm.

The present invention has proven to be particularly advantageous when the first part of the liquid line is formed as a pump nozzle and the second part of the liquid line is formed as a pump hose. In addition, the tear-off coupling is preferably arranged on the second liquid connector of the coupling element.

The anti-twist means according to the invention may comprise two permanent magnets. These are preferably arranged such that the pole of one permanent magnet cooperates with the antipole of the other permanent magnet. The anti-twist means is more preferably designed such that a pole of one permanent magnet releases from the antipole of the other permanent magnet under the action of a defined torque between the first part of the liquid line and the coupling element.

In a preferred embodiment the anti-twist means comprises a securing pin. This may engage with an indentation corresponding to the securing pin. The securing pin preferably releases from the indentation under the action of a defined torque between the first part of the liquid line and the coupling element. It may be that the securing pin breaks under the action of a defined torque. Once the securing pin has broken, the first part of the liquid line can be freely rotated relative to the coupling element.

In a preferred embodiment, however, the securing pin is pressed into the indentation with the aid of a restoring element. For example, the restoring element may be a spring. The securing pin more preferably unlatches from the indentation via an inclined surface under the action of a defined torque between the first part of the liquid line and the coupling element. Under the action of a small torque the securing pin thus presses laterally against the inclined surface and is blocked thereby. Here, part of the torque is converted into a force that opposes the spring force. However, only when the defined torque is effective is this force large enough to overcome the spring force. In this case the securing pin is moved in the direction of the spring, such that the securing pin is no longer blocked by the inclined surface. In this case a rotation is possible. An anti-twist means of this type has the advantage that the anti-twist means is not destroyed by a rotation and can be brought back into the original position, in which the securing pin engages with the indentation.

As considered from the middle position of the indentation, two inclined surfaces rising in the peripheral direction are preferably provided. In this case, the anti-twist means acts in both directions of rotation.

The anti-twist means preferably also comprises a ring element having a plurality of indentations arranged in a circle. One of the indentations may be selected, with which the securing pin is to be brought into engagement. An angular position between the first part of the liquid line and the coupling element is thus set, in which position the first part of the liquid line and the coupling element are secured relative to one another. It is possible to make a selection from a plurality of such angular positions on account of the circular ring element.

The coupling element according to the invention is particularly advantageous in the case of modern filling pumps, in which the pump hose comes out from the filling pump at a point below the hanging point of the pump nozzle in the filling pump and below the conventional height of the filler neck of a vehicle. Here, the pump nozzle must be rotated through 180° about a substantially vertical axis during the process of removal from the mount in the filling pump and insertion into the filler neck of the vehicle. It may be that for this purpose a free rotation between the coupling element and the second part of the liquid line is possible at the second liquid connector of the coupling element.

The coupling element according to the invention, however, may also be used on other types of filling pumps, in which the pump hose comes out from the filling pump for example on the side of the filling pump, at a height above the conventional height of a filler neck. Here, it may be that the anti-twist means can be switched off and that in the switched-off state a free relative rotation between the coupling element and the first part of the liquid line is possible. The additional easy rotatability achievable in this way makes it possible to insert the pump nozzle more comfortably into the filler neck in the case of filling pumps of this type.

The present invention also relates to a pump nozzle comprising a coupling element according to the invention. The coupling element according to the invention can be used in conjunction with pump nozzles in which return channels for example for returning vapors of petrol fuels are formed in coaxial design. The coupling element according to the invention may also be used in conjunction with pump nozzles for diesel fuels, in which no return channels for fuel vapors are provided.

The invention also relates to a filling pump that has a pump nozzle having a coupling element according to the invention.

The invention will be described hereinafter on the basis of an advantageous embodiment with reference to the accompanying drawings, in which:

FIG. 1 shows a pump nozzle having a coupling element according to the invention;

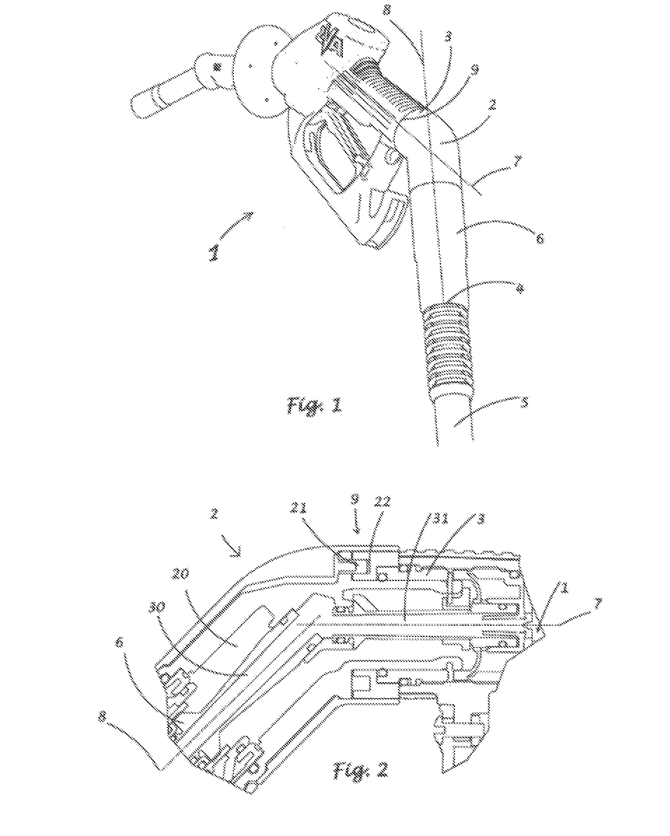

FIG. 2 shows a sectional illustration from the side through a first embodiment of a coupling element according to the invention;

FIG. 3 shows a sectional illustration from the side through a second embodiment of a coupling element according to the invention;

FIG. 4 shows a sectional illustration in the peripheral direction through a securing pin of a third embodiment of the coupling element, wherein the securing pin engages with an indentation;

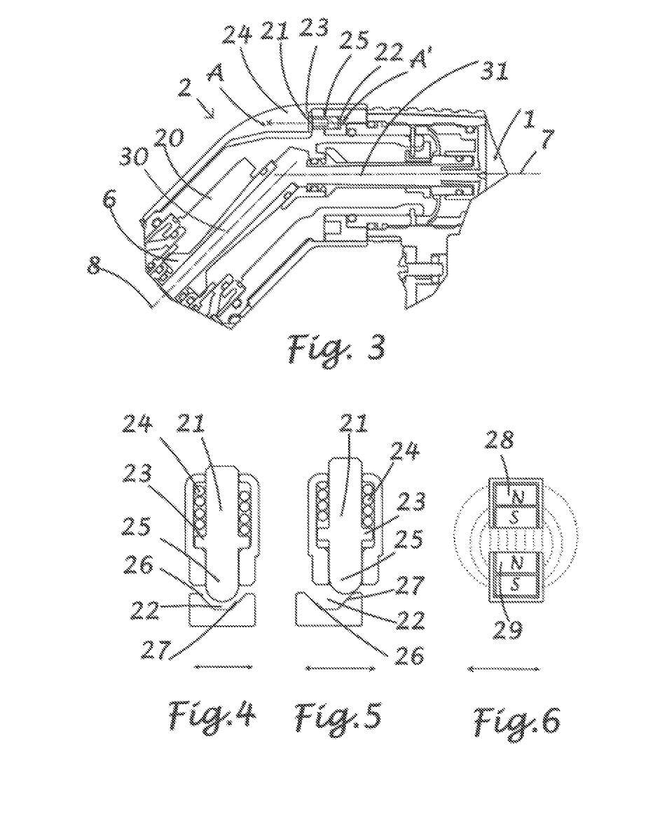

FIG. 5 shows a sectional illustration in the peripheral direction through a securing pin of a third embodiment according to the invention of the coupling element, wherein the securing pin is unlatched from the indentation;

FIG. 6 shows a sectional illustration in the peripheral direction through a securing element of a fourth embodiment according to the invention of the coupling element, which comprises two permanent magnets;

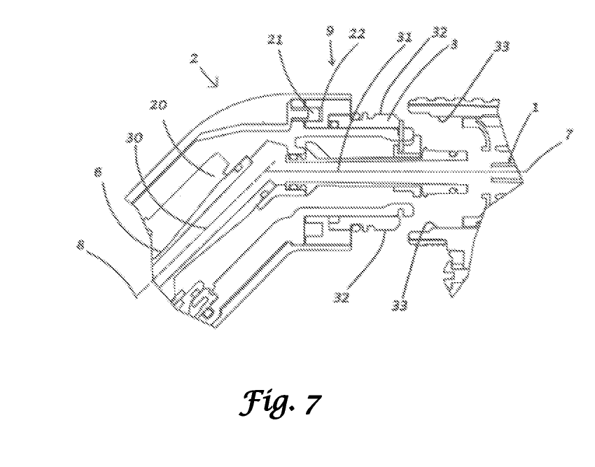

FIG. 7 shows a sectional illustration from the side of the connection region between a coupling element according to the invention and a pump nozzle in the unconnected state.

FIG. 1 shows a pump nozzle 1 for refueling a motor vehicle, having a coupling element 2 according to the invention. The coupling element 2 connects a pump nozzle 1 to a pump hose 5, which leads further to a filling pump (not shown). Here, a first liquid connector 3 is used for connection to the pump nozzle 1 and a second liquid connector 4 is used for connection to the pump hose 5. A tear-off coupling 6 is located on the second liquid connector 4. The longitudinal axis 7 defined by the first liquid connector 3 encloses an angle of approximately 45° with the longitudinal axis 8 defined by the second liquid connector 4. In other embodiments this angle may lie between 0° and 180°. Whereas the hose 5 is freely rotatable about the longitudinal axis 8 relative to the coupling element 2, the pump nozzle 1 is fixed relative to the coupling element 2 via a screw connection (not shown). However, an anti-twist means 9 is located on the first liquid connector 3 and allows a relative rotation between the coupling element 2 and the pump nozzle about the longitudinal axis 7 only when a defined torque acts between the coupling element 2 and the pump nozzle 1.

FIG. 2 shows a lateral sectional illustration of a first embodiment of the coupling element 2 according to the invention. Here, the tear-off coupling 6 is illustrated only in part, and part of the pump nozzle 1 is additionally also shown. The pump nozzle 1 is screwed to the coupling element 2. FIG. 7 shows the pump nozzle 1 and the coupling element 2 in an unconnected state, in which the screw connection can be seen. The screw connection consists of a thread 32 arranged on the coupling element 2 and also of a mating thread 33 arranged on the pump nozzle 1. In the sectional illustration of FIG. 2 it can be seen how the liquid connectors 3 and 4 are interconnected via a channel 20 within the coupling element. Return channels 30, 31 are additionally formed, in which fuel vapors for example can be returned.

FIG. 2 also shows the anti-twist means 9, which is arranged in the vicinity of the liquid connector 3. Within the anti-twist means 9, a securing pin 21 engages with a corresponding indentation 22. As the pump nozzle 1 is rotated relative to the coupling element 2 about the axis 7, the part of the securing pin 21 engaging with the indentation 22 contacts one of the side faces of the indentation 22 in the peripheral direction and thus prevents a relative rotation of the pump nozzle 1 relative to the coupling element 2. If the effective torque reaches a value of 30 Nm, the securing pin 21 breaks, such that a rotation can take place.

FIG. 3 shows a further embodiment of a coupling element according to the invention. In contrast to the embodiment shown in FIG. 2, the securing pin 21 has a peripheral protrusion 23, to which a spring 24 is fastened. The spring 24 presses the securing pin 21 into the indentation 22. Under the action of a torque between the pump nozzle 1 and the coupling element 2, the part 25 of the securing pin 21 engaging with the indentation presses in the peripheral direction against one of the side faces of the indentation 22. A relative rotation is thus prevented. Provided the effective torque reaches a value of 30 Nm, the securing pin 21 slides against the spring force of the spring 24 over the edge of the indentation 22, such that a rotation can take place. This will be explained in greater detail hereinafter.

A detailed sectional view along the line AA′ shown in FIG. 3 is shown in FIG. 4, wherein the section is shown in the peripheral direction, i.e. into the drawing plane. In FIG. 4 the peripheral direction is indicated by the double-headed arrow. The securing pin 21 engages with the indentation 22. In this view it can be seen that the indentation 22 has two inclined surfaces 26, 27, which rise from the middle of the indentation 22 as considered in the peripheral direction toward the spring 24. The securing pin 21 is shaped at its part 25 engaging with the indentation 22 such that it terminates flush with the inclined surfaces. For improved illustration, however, a gap is provided in FIG. 4 between the part 25 of the securing pin and the inclined surfaces 26, 27. The spring force presses the securing pin 21 into the indentation 22. Under the action of a torque of 30 Nm in the peripheral direction, the securing pin 21 is pressed against the inclined surface 26 or 27 depending on the direction of rotation. The counterforce caused by the inclined surface acts normal to the inclined surface, such that a component of the counterforce acts against the direction of rotation and thus prevents a rotation. The other component of the counterforce acts upwardly in FIG. 4, i.e. against the spring force. Provided the defined torque is effective, the upwardly directed component is large enough to exceed the spring force and to compress the spring 24. The securing pin 21 is thus moved upwardly out of the indentation, and a relative rotation can take place. This state is shown in FIG. 5.

In a further embodiment of the coupling element according to the invention two permanent magnets 28, 29 are provided instead of the securing pin 21, wherein the south pole of the permanent magnet 28 is located opposite the north pole of the permanent magnet 29. This is shown in FIG. 6. On account of the magnetic force of attraction between the north and south poles, a relative rotation in the peripheral direction (indicated by the double-headed arrow) between the pump nozzle 1 and the coupling element 2 is not possible. Only under the action of a defined torque is the force of attraction of the permanent magnets 28, 29 overcome, so that these are released from one another and a further rotation is possible.

1. A coupling element (2) comprising a first liquid connector (3) for connection to a first part of a liquid line (1), a second liquid connector (4) for connection to a second part of a liquid line (5), and a tear-off coupling (6), wherein the two longitudinal axes (7, 8) of the liquid connectors (3, 4) are angled relative to one another, and wherein the first liquid connector (3) is designed to produce a screw connection to the first part of the liquid line (1), characterized in that an anti-twist means (9) is provided on the first liquid connector (3) of the coupling element (2) and allows a relative rotation between the first part of the liquid line (1) and the coupling element (2) when a defined torque acts between the first part of the liquid line (1) and the coupling element (2).

2. The coupling element as claimed in claim 1, characterized in that the anti-twist means (9) allows a relative rotation between the first part of the liquid line (1) and the coupling element (2) when a torque is effective that is smaller than the torque necessary to release a screw connection between the anti-twist means (9) and the first part of the liquid line (1).

3. The coupling element as claimed in claim 2, characterized in that the anti-twist means (9) allows a relative rotation between the first part of the liquid line (1) and the coupling element (2) when a torque is effective that lies between 10 Nm and 40 Nm, preferably between 20 Nm and 30 Nm.

4. The coupling element as claimed in one of the preceding claims, characterized in that the first part of the liquid line (1) is designed as a pump nozzle and the second part of the liquid line (5) is designed as a pump hose.

5. The coupling element as claimed in claim 4, characterized in that the tear-off coupling (6) is arranged on the second liquid connector (4) of the coupling element (2).

6. The coupling element as claimed in one of the preceding claims, characterized in that the anti-twist means (9) comprises two permanent magnets (28, 29).

7. The coupling element as claimed in claim 6, characterized in that one pole of one permanent magnet releases from the antipole of the other permanent magnet under the action of a defined torque between the first part of the liquid line (1) and a coupling element (2).

8. The coupling element as claimed in one of claims 1 to 5, characterized in that the anti-twist means (9) comprises a securing pin (21).

9. The coupling element as claimed in claim 8, characterized in that the securing pin (21) engages with an indentation (22) corresponding to the securing pin (21), and in that the securing pin (21) releases from the indentation (22) under the action of a defined torque between the first part of the liquid line (1) and the coupling element (2).

10. The coupling element as claimed in claim 9, characterized in that the securing pin (21) breaks under the action of a defined torque between the first part of the liquid line (1) and the coupling element (2).

11. The coupling element as claimed in claim 9, characterized in that the securing pin (21) is pressed with the aid of a restoring element (24) into the indentation (22) and is unlatched from the indentation (22) via an inclined surface (26) under the action of a defined torque between the first part of the liquid line (1) and the coupling element (2).

12. The coupling element as claimed in one of the preceding claims, characterized in that a free rotation between the coupling element (2) and the second part of the liquid line (5) is possible at the second liquid connector (4) of the coupling element.

13. The coupling element as claimed of the preceding claims, characterized in that the anti-twist means (9) can be switched off, and in that in the switched-off state a free relative rotation between the coupling element (2) and the first part of the liquid line (1) is possible.

14. A pump nozzle, characterized in that it has a coupling element as claimed in one of claims 1 to 13, wherein a screw connection exists between the pump nozzle and the first liquid connector (3) of the coupling element (2).

15. A filling pump, characterized in that it has a pump nozzle as claimed in claim 14.
